(19) United States
(12) Patent Application Publication
(10) Pub. No.: US 2015/0356041 A1
(43) Pub. Date: Dec. 10, 2015

(54) IDENTIFYING INTERFACES

(71) Applicant: Cisco Technology, Inc., San Jose, CA (US)

(72) Inventor: LIOR BARNUR, Netanya (IL)

(21) Appl. No.: 14/299,981

(22) Filed: Jun. 9, 2014

(51) Int. Cl. G06F 13/40; G06F 13/42

(52) U.S. Cl. CPC G06F 13/4022; G06F 13/4221

(57) ABSTRACT

A method and apparatus is provided for identifying a particular computer port. A first instruction is sent to a computer. The first instruction specifies a particular port of the computer and relates to an indicator uniquely associated with, and located proximate to the specified particular port. Upon an execution of the first instruction, the indicator is configured to provide an identification signal. A current operative state of the port is maintained while the indicator associated therewith simultaneously provides the identification signal.

### FIELD OF THE DISCLOSURE

The present disclosure generally relates to computing devices having interfaces, ports or other external connections with status indicators. The disclosure relates more specifically to techniques for identifying interface connections on computing devices including internetworking equipment such as routers and switches.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computing systems may comprise routers, switches and other apparatus operable for sustaining or supporting data transfer over packet switched and other communication networks. Computing systems may also comprise server and client computer apparatus and various other data processing devices. These devices may have hardware interfaces for physically coupling, via communication media, with one or more other computers for exchanging or transacting data therewith.

As used herein, the term “port” relates to a physical interface installed with hardware of a computer and configured for coupling the computer to a communication medium. At a physical level, the ports comprise specialized outlets for components of each computing system, which are configured for communicatively coupling the computer to optical or electrical media for transacting (e.g., sending and/or receiving) data signals therewith. Such communication media may include fiber optic, coaxial, telephone cables and other data signal conductors as well as wireless means. Conductive components of the ports allow the transfer of signals between the computer and other computers via the communication media with which they are coupled.

In some cases routers, switches or other devices may have a large number of ports. The devices may be arranged in modules that are stacked in a rack with power supplies, cooling fans and other auxiliary features. Large numbers of the devices may be located in data centers or other facilities. The number of ports multiplies as racks are added and apparatus are tiered. Connecting communication cables correctly to such large numbers of ports is not a trivial exercise and errors are possible even with connecting relatively few ports. Each port is physically associated with a particular electronic component of a computer. Each component and each computer have particular individual operational functions in exchanging data signals with other computers. Thus, the physical identity of a specific port on a specific computer is significant. For proper communications to occur between a number of computers, correct communication cables must be connected with their respectively correct ports. As the number of ports grows among them however, their connection populations (including their interconnections) grow and become more complex and maintaining correct connections becomes even less trivial.

### SUMMARY

The appended claims may serve as a summary of the invention.

### BRIEF DESCRIPTION OF THE DRAWINGS

In the drawings:

FIG. 1 illustrates a rear perspective view of an internetworking device having an array of ports.

FIG. 2 depicts an example communication system, according to an example embodiment of the present invention;

FIG. 3 depicts a flowchart for an example computer-implemented method for uniquely identifying a port, according to an example embodiment of the present invention;

FIG. 4 illustrates a computer system with which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1. OVERVIEW

In an embodiment, a computer-implemented method comprises receiving a first instruction at a computer, wherein the first instruction is configured to specify a particular port of the computer; in response to the first instruction, causing displaying an identification signal using an indicator that is uniquely associated with, and located proximate to, the particular port specified in the first instruction; maintaining a current operative state of the port while the indicator associated therewith simultaneously provides the identification signal; wherein the method is performed by one or more computing devices.

In another embodiment, a computing apparatus comprises one or more processors coupled to a bus; port signaling logic coupled to the bus and comprising a non-transitory data storage medium storing one or more sequences of instructions which when executed using the one or more processors cause performing: receiving a first instruction at a computer, wherein the first instruction is configured to specify a particular port of the computer; in response to the first instruction, causing displaying an identification signal using an indicator that is uniquely associated with, and located proximate to, the particular port specified in the first instruction; maintaining a current operative state of the port while the indicator associated therewith simultaneously provides the identification signal; wherein the method is performed by one or more computing devices.

In still another embodiment, a computer-implemented method comprises receiving a first instruction at an internetworking device, wherein the first instruction is configured to specify a particular port of the internetworking device; in response to the first instruction, causing displaying an identification signal using a light-emitting diode (LED) that is uniquely associated with, and located proximate to, the particular port specified in the first instruction while maintaining a current operative state of the port; receiving a second instruction at the internetworking device, wherein the second instruction is configured to specify the particular port, and in response to the second instruction, stopping the identification signal while maintaining the current operative state of the port; in association with stopping the identification signal, reconfiguring the LED associated with the port to provide a signal relating to a current operating state of the port; wherein the identification signal has a first characteristic and the signal relating to the current operating state of the port has a second characteristic, which is distinct from the first characteristic; wherein the first characteristic comprises blinking according to a first pattern and the second characteristic comprises blinking according to a second pattern that is visually distinguishable from the first pattern based upon one or more of (a) an interval between illumination and non-illumination and (b) a length of illumination or non-illumination; wherein the method is performed by one or more computing devices.

### 2. STRUCTURAL AND FUNCTIONAL EXAMPLE

For purposes of illustrating a clear example, specific embodiments are described in the context of internetworking equipment such as routers and switches. However, the techniques described herein apply generally to any computing device having a port, interface, or other external connection that has a status indicator that is capable of control for the purpose of distinctive patterns of illumination or signaling. For example, digital electronic hardware used in power grids, water systems, or other contexts, in which the hardware has some form of external connection with an associated status indicator, may be the subject of these techniques.

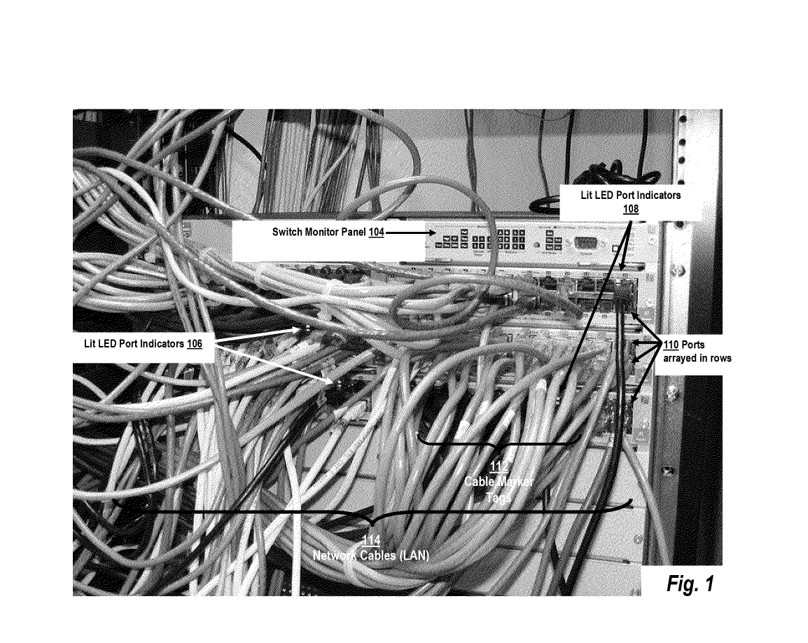

FIG. 1 illustrates a rear perspective view of an internetworking device having an array of ports. For example, FIG. 1 may comprise the connection side of a network switch apparatus. In an embodiment, a network switch apparatus comprises one or more chassis in which one chassis has a monitor panel 104, which has visual indicators to show operators the status of the apparatus. The monitor panel 104 may also signal other computers in relation to the switch status.

Several components of the switch are stacked in a rack beneath monitor panel 104. The stacked switch components each have several rows of ports 110. Each of the ports 110 is identified by a unique port identifier or address, which is labeled (e.g., numerically, alphanumerically, graphically) directly above each port. A number of communication cables 114 are connected to the switch. Each of the cables 114 is identified by an identifying marker tag 112.

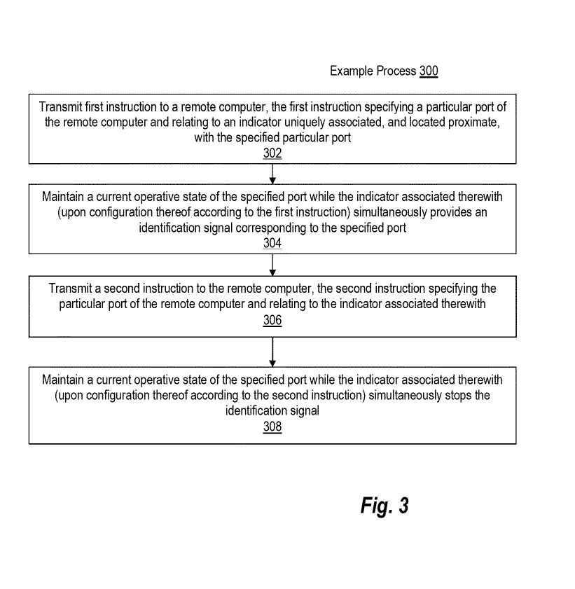

Port activities (e.g., status, signal exchange therewith, etc.) are indicated by a light emitting diode (LED) associated with the port. In the example of FIG. 1, lit LED port indicators 106, 108 may be associated with different ports and each port typically has one or more LED indicators. As shown in FIG. 3B, a lit LED 108 positively indicates port activity whereas a dark LED may indicate no activity. The LEDs may light continuously or in various patterns, each of which may uniquely indicate a particular port activity. Using the port identifier labels and cable identity marker tags 112 to find the correct port, operators and technicians may then check and monitor them with particularity, in sustaining and maintaining a network and its operations.

Notwithstanding their general helpfulness however, port identifier labels and cable identity marker tags are unfortunately not a panacea to port misidentification and concomitant connection errors and communication problems. Port misidentification may be particularly vexing with greater numbers of ports, as for example in large modern data centers. Situations may arise in operating the data center however in which the tagged cables and labeled ports do not suffice to identify particular physical ports positively and definitely. In network operations for example, technicians may be sent to test or maintain network apparatus at site locations separate from a network operator in which an operator retains exclusive access control over the apparatus. To perform a particular test or maintenance function, the technicians may be directed to change the status of (e.g., disconnect the cable from) a specific port of a given computer or perform another task associated therewith. In this scenario, the technicians must coordinate with the operator to verify that they are accessing a particular port. An error, such as disconnecting another cable from a different port, can cause a communication problem. Communication problems in a data center may lead to outages, which can be costly and destructive.

Errors such as connecting a communication cable to an incorrect port may also cause communication problems. Such errors are unfortunately not always uncommon. For example, while technicians typically try to keep track of multiple ports while connecting, disconnecting and reconnecting communication cables therewith, they may fail to properly log such activities. Human factors such as fatigue and confusion (e.g., perhaps associated with shift changes) may contribute to the possibility of errors and in any event, the complexity and related demands of the technical environment remain non-trivial.

Even working with a single particular port for example, simply taking their eyes off of it, or distractions by other indications or issues can cause technicians to lose track and err. Planned maintenance of network apparatus may involve scheduled outages. Even with sufficient planning, technicians typically find themselves working under pressure to minimize downtime and associated costs. Such pressure may add to negative human factors and thus exacerbate the possibility of error.

Connection errors are also sometimes caused by nonexistent, poorly visible or erroneous identification marking of apparatus and other devices and ports thereof and/or communication cables connected therewith. Identification markers may also be marred by wear, erasures, fading and chemical decomposition, over-writes and “incorrect ‘corrections’,” tape, paint, dust, deposits or other coverings, inadvertent (or even malicious) removal or destruction.

Moreover, the possibility of port connection errors may be multiplied with computers set in multi-chassis, multi-rack network gear or by cluttered, unworkmanlike, disorganized or poorly lit settings. Simply improving the identification markers for ports, associated slots and connected cables is often not completely effective with such cluttered gear, sometimes considered unworkmanlike or referred to as a “rat's nest.” Furthermore, any such improvements may also be subsequently lost, marred, obscured or occluded.

In one approach the state of a port may be changed to a ‘no shut’ state, in which its respective port status LED is lit in a pattern indicating a ‘down’ state. However, the port state change approach often remains inadequate in complex multi-chassis or cluttered environments and inadvertent shutting of an ‘up’ interface may increase downtime. Further, the port state change approach can be time consuming and add risk to network stability.

In another approach a ‘port time out’ approach has been used. For example, an off-site operator with administrative control or other exclusive access privileges to a remote network apparatus may coordinate with a non-privileged on-site technician and thus instruct the technician to disconnect a selected port on a particular computer for a specified time duration (e.g., three seconds). As three seconds may often be specified as the test time duration, this is sometimes referred to as a “3-second rule.” Upon a report of the disconnection, the operator awaits expected automatic actuation system alarms relevant to indicating the identity of the port thus disconnected. Simultaneously, the technician may observe for indication of the port disconnection, as may be reflected on the port status LED or other local indicia. Upon mutual agreement of the operator and the technician as to verifying the identity of the port thus disconnected, maintenance may then be performed in relation thereto. In the event an error is thus realized on the other hand, the technician may quickly reconnect the erroneously disconnected port to reestablish communication therewith after an outage, which is limited to the brief (e.g., three second) duration of the erroneous disconnection. This approach however is unacceptable in delay-sensitive applications such as voice and video conferencing and may be considered improper by some users in any application. Moreover, some ports (e.g., those comprising power outlets) may sustain undesirable effects of durations that exceed mere brief traffic delay.

In an embodiment, a method, apparatus and communication system are described for identifying a particular computer port. A first instruction is sent to a remote computer. The first instruction specifies a particular port of the remote computer and relates to an indicator uniquely associated with, and located proximate to the specified particular port. Upon an execution of the first instruction, the indicator is configured to provide an identification signal. A current operative state of the port is maintained while the indicator associated therewith simultaneously provides the identification signal.

A second instruction may be sent to the remote computer. The second instruction specifies the particular port of the remote computer and relates to the indicator associated therewith. Upon an execution of the second instruction, the indicator is configured to stop the identification signal. The current operative state of the port is maintained while the indicator associated therewith simultaneously stops the identification signal.

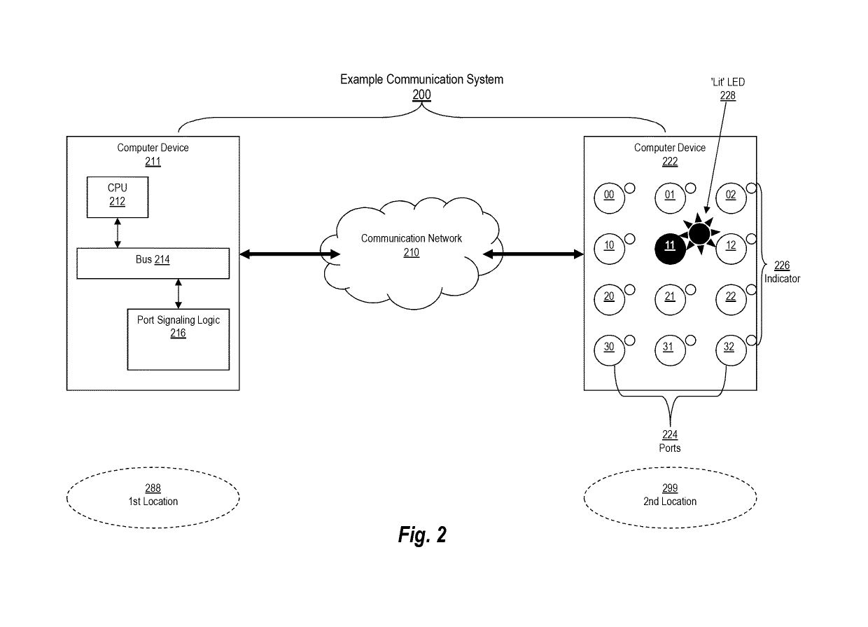

FIG. 2 depicts an example communication system according to an embodiment. The communication system 200 comprises a first computer device 211 at a first location 288 and a second computer device 222 at a second location 299. The second location 299 is separate in relation to the first location 288 and may be considered remote, but in this context, the term “remote” refers to a separation of any distance. For example, the computer device 222 may thus be located in a separate facility quite distant from the computer device 211, or both computer devices may be different locations within in the same facility. In addition, first computer device 211 could be a handheld computer, laptop computer, smartphone, tablet computer, ultrabook or netbook that is wireless and portable, so that a technician or administrator could operate the first computer device 211 while in the data center, rack room, or other location proximate to second computer device 222. Alternatively, the first computer device 211 may be at a network operations center (NOC) that is a long distance from the second location 299, for example, when a technician with no access privileges to the second computer device 222 is local to that device and working by phone or network communication with a NOC operator who is directing work on the second device.

A communication network 210 allows computer device 211 to transmit instructions to computer device 222. The communication network 210 may comprise a packet switched data network, a telephone network, and/or a combination of one or more local networks, wide area networks, and/or internetworks. Thus multiple networks may combine to comprise network 210 and network 210 may comprise one or more component networks.

The computer device 211 comprises a processor such as a CPU) 212 that is coupled to a bus 214. Computer device 211 also comprises port signaling logic 216 coupled to the bus 214. The processor 212 is operable with the port signaling logic 216 for transmitting instructions via the network 210 to the computer device 222. Further, the port signaling logic 216 may implement the process of FIG. 3 that is described in separate sections herein. Port signaling logic 216 may comprise one or more computer programs, other software elements, and/or digital logic. In one embodiment, port signaling logic 216 may be embodied as executable code or instructions that implement a signaling command as part of a command-line interface (CLI) of an operating system of a network management station or other form of computer.

The computer device 222 comprises an array of ports 224. For purposes of illustrating a clear example, twelve (12) ports 224 are shown in FIG. 2, arranged IN four rows (00, 10, 20 and 30) of three columns (00, 01 and 02). Each of the ports 224 has a visible indicator 226 associated therewith, which is located in close proximity with its respective port. In one embodiment, each visible indicator 226 is an LED but other embodiments may use e-paper displays, incandescent lamps, or other indicators.

The processor 212 of computer device 211 is further operable for performing, or controlling the computer device 211 in performing, various computer-implemented processes. For example, computer device 211 may be operable with the communication network 210 for performing a process related to identifiably specifying a particular port (e.g., port 11) among the array of ports 224 of computer device 222. In an embodiment, computer device 222 includes, as part of the ports 224, driver circuitry, other interface hardware, or an operating system, logic in the form of hardware, firmware, software or a combination that is configured to execute signaling instructions that are received from the first computer device 211. For example, in one arrangement, the first computer device 211 issues commands and instructions relating to particular patterns of illuminating the visible indicator 226 that is associated with a particular port 224, and the ports themselves or associated driver circuitry, other interface hardware, or an operating system, logic in the form of hardware, firmware, software or a combination thereof at the second computer device 222 are configured to execute the commands by illuminating the visible indicator 226 as specified in the commands. As another example, the techniques herein could be implemented by defining a new command of an operating system of the second computer device 222, and issuing that new command from the first computer device 211 to the second computer device 222, or issuing that new command using a console or terminal that is coupled to the computer device 222.

FIG. 3 illustrates an example computer-implemented process 300 for uniquely identifying a port, according to an example embodiment. In one embodiment, computer device 211 (FIG. 2) may be operable for performing process 300 to identifiably specify a particular port among the array of ports 224 of computer device 222.

In step 302, a first instruction is transmitted to a computer. The first instruction specifies a particular port of the computer and relates to an indicator uniquely associated with, and located proximate to, the specified particular port. For example, the first instruction may specify port 11 in particular, from among the array of ports 224 of computer device 222.

Optionally, the first instruction also comprises pattern data that specifies a particular illumination pattern for the indicator from among a plurality of different available illumination patterns, where at least one of the plurality of available illumination patterns is different than a second particular illumination pattern that is associated with normal operation of the particular port. The available illumination patterns may be hard-coded into the logic that implements the process so that the pattern data may be a number or character serving as an index into a list, table or other structure of programmed patterns. Additionally or alternatively, the pattern data may explicitly specify an illumination pattern using a code to indicate a length of illumination, length of non-illumination, blink interval, duty cycle, or similar values, which are then interpreted by the process or logic when the first instruction is executed to cause producing the specified illumination pattern.

For example, the method may be implemented with a first illumination approach that comprises blinking according to a first pattern and a second illumination approach that comprises blinking according to a second pattern that is visually distinguishable from the first pattern based upon one or more of (a) an interval between illumination and non-illumination and (b) a length of illumination or non-illumination. In this manner, the method of flashing an LED for a port may be specified in a CLI command, GUI operation, or using programmatic means so that a NOC operator, administrator, user or program can specify custom blink patterns to be used at particular times. For example, one blink pattern might indicate a port having an urgent need for corrective action while a different pattern could indicate a misconfiguration that has less impact. In all such cases, the blink pattern typically is to attract attention and is not related to an indication of normal data transmission activity of the port.

In step 304, a current operative state of the specified port is maintained while the indicator 228 associated therewith and proximate thereto, upon configuration thereof according to the first instruction, simultaneously provides an identification signal corresponding to the specified port. Notwithstanding a population of multiple and perhaps similar ports, the identification signal accurately informs technicians in the vicinity of computing device 222, who may have tasks related to the specified port, as to the correct identity thereof with exact precision. Moreover, the port operative state remains reliably stable while the port is thus identified.

After a specified or configurable length of time, or receipt of a notification that a need for identifying the specified port has passed, a second instruction is transmitted in step 306 to the computer. Like the first instruction, the second instruction also specifies the particular port of the computer and relates to the indicator associated therewith.

In step 308, the current operative state of the specified port is again maintained; this time while the indicator associated therewith, upon configuration thereof according to the second instruction, simultaneously stops the identification signal corresponding to the specified port. At this point, the indicator may return to signaling the current operative state of the port or the like.

The identification signal has a first characteristic and the signal relating to the current operating state of the port has a second characteristic, which is distinct from the first characteristic. In an example embodiment of the present invention, the indicator associated with the port comprises a visual indicator, which may be implemented with a light source (e.g., LED). In an example embodiment, the first characteristic and the second characteristic each relate to an illumination state of the light source. The illumination state comprises either a lit appearance of the light source or a non-lit appearance of the light source. The lit appearance and the non-lit appearance of the light source may alternate, for example with a blink pattern.

While the blink pattern of the lit LED 228 accurately indicates the identity of the specified port 11, the other indicators 226 associated with the other ports 00, 01, 02, 10, 12, 20, 21, 22, 30, 31 and 32 (inclusive) may each display blink patterns that are distinct from the identification blink pattern, which may correspond with the respective current state of each of the other ports. In FIG. 2, the label “Lit” is used in the sense that the identification signal bit pattern is actively provided. Alternatively one or more of the other LEDs 226 may also display a distinctly differently lit pattern or remain unlit, e.g., in relation to the current operative state of their respective ports.

In some embodiments at least a third instruction may be transmitted to the computer. An example embodiment may be implemented in which the blink pattern is configured according to the third instruction.

An example embodiment may be implemented in which the blink pattern is configured in relation to a period or frequency of the blink pattern or a beat associated therewith. The blink pattern may also be configured with a time span during which the indicator provides the identification signal. The blink pattern may be a specific known blink pattern on command that is initiated using any method of port control, including CLI commands or GUI instructions. The CLI may include a “blink” command to start a blink pattern and/or a “no blink” command to stop the blink pattern when work is done.

In some embodiments, the operation of the approaches herein does not affect or interrupt the regular working status of a port. Embodiments may be implemented using code that instructs a port card or other port-related electronics to blink the LED associated with a port as a discrete operation without any other change in port operations.

Embodiments can effectively address the problem scenarios described above. For example, embodiments provide a positive and definite method of identifying physical ports on devices. The approaches are effective for remote on-site technicians who have no access privileges to devices by enabling both a network operations center (NOC) operator and the technician to verify that they are working on the correct port prior to starting work, avoiding costly network outages. Embodiments are effective for keeping track of ports while connecting or disconnecting them, even in the face of pressure to avoid network downtime where distractions can cause errors. The approaches can be used with devices that are poorly marked, unmarked, affected by erased or removed markings, poorly designed markings, multi-chassis environments with a thicket of cables, and other cluttered or disorganized environments.

### 3. IMPLEMENTATION EXAMPLE

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

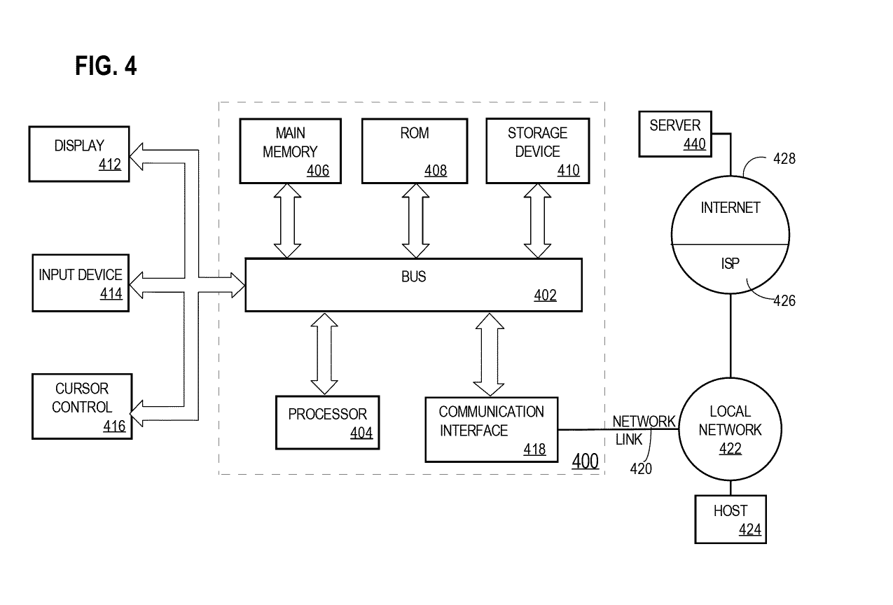

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, for example a liquid crystal display (LCD) or cathode ray tube (CRT), for displaying information to a computer user. An input device 414, including alphanumeric and other keys, is coupled to bus 402 for communicating information and command selections to processor 404. Another type of user input device is cursor control 416, such as a touch-sensitive display screen, touchpad, mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane; input in three dimensions in the form of complex gestures with accelerometer input or other input may be used as well.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a computer. The computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A computer-implemented method, comprising:
receiving a first instruction at a computer, wherein the first instruction is configured to specify a particular port of the computer;
in response to the first instruction, causing displaying an identification signal using an indicator that is uniquely associated with, and located proximate to, the particular port specified in the first instruction;
maintaining a current operative state of the port while the indicator associated therewith simultaneously provides the identification signal;
wherein the method is performed by one or more computing devices.

2. The method as recited in claim 1, further comprising:
receiving a second instruction at the computer, wherein the second instruction is configured to specify the particular port of the computer;
in response to the second instruction, stopping the identification signal;
maintaining the current operative state of the port while the indicator associated therewith simultaneously stops the identification signal.

3. The method as recited in claim 2, further comprising, in association with stopping the identification signal, reconfiguring the indicator associated with the port to provide a signal relating to a current operating state of the port.

4. The method as recited in claim 3 wherein the identification signal has a first characteristic and the signal relating to the current operating state of the port has a second characteristic, which is distinct from the first characteristic.

5. The method as recited in claim 1, wherein the indicator associated with the port comprises a visual indicator.

6. The method as recited in claim 1, wherein the indicator associated with the port comprises a light emitting diode (LED).

7. The method of claim 1 wherein the identification signal comprises blinking.

8. The method of claim 4 wherein the first characteristic comprises blinking according to a first pattern and the second characteristic comprises blinking according to a second pattern that is visually distinguishable from the first pattern based upon one or more of (a) an interval between illumination and non-illumination and (b) a length of illumination or non-illumination.

9. The method of claim 1 wherein the first instruction further comprises pattern data that specifies a particular illumination pattern for the indicator from among a plurality of different available illumination patterns, and wherein at least one of the plurality of available illumination patterns is different than a second particular illumination pattern that is associated with normal operation of the particular port.

10. A computer comprising:
one or more processors coupled to a bus;
port signaling logic coupled to the bus and comprising a non-transitory data storage medium storing one or more sequences of instructions which when executed using the one or more processors cause performing:
receiving a first instruction at the computer, wherein the first instruction is configured to specify a particular port of the computer;
in response to the first instruction, causing displaying an identification signal using an indicator that is uniquely associated with, and located proximate to, the particular port specified in the first instruction;
maintaining a current operative state of the port while the indicator associated therewith simultaneously provides the identification signal;
wherein the method is performed by one or more computing devices.

11. The computer as recited in claim 10, further comprising sequences of instructions which when executed cause performing:
receiving a second instruction at the computer, wherein the second instruction is configured to specify the particular port of the computer;
in response to the second instruction, stopping the identification signal;
maintaining the current operative state of the port while the indicator associated therewith simultaneously stops the identification signal.

12. The computer as recited in claim 11, further comprising sequences of instructions which when executed cause performing, in association with stopping the identification signal, reconfiguring the indicator associated with the port to provide a signal relating to a current operating state of the port.

13. The computer as recited in claim 10, wherein the identification signal has a first characteristic and the signal relating to the current operating state of the port has a second characteristic, which is distinct from the first characteristic.

14. The computer as recited in claim 10, wherein the indicator associated with the port comprises a visual indicator.

15. The computer as recited in claim 10, wherein the indicator associated with the port comprises a light emitting diode (LED).

16. The computer as recited in claim 10, wherein the identification signal comprises blinking.

17. The computer as recited in claim 13, wherein the first characteristic comprises blinking according to a first pattern and the second characteristic comprises blinking according to a second pattern that is visually distinguishable from the first pattern based upon one or more of (a) an interval between illumination and non-illumination and (b) a length of illumination or non-illumination.

18. The computer as recited in claim 10, wherein the first instruction further comprises pattern data that specifies a particular illumination pattern for the indicator from among a plurality of different available illumination patterns, and wherein at least one of the plurality of available illumination patterns is different than a second particular illumination pattern that is associated with normal operation of the particular port.

19. A computer-implemented method, comprising:
receiving a first instruction at an internetworking device, wherein the first instruction is configured to specify a particular port of the internetworking device;
in response to the first instruction, causing displaying an identification signal using a light-emitting diode (LED) that is uniquely associated with, and located proximate to, the particular port specified in the first instruction while maintaining a current operative state of the port;
receiving a second instruction at the internetworking device, wherein the second instruction is configured to specify the particular port, and in response to the second instruction, stopping the identification signal while maintaining the current operative state of the port;
in association with stopping the identification signal, reconfiguring the LED associated with the port to provide a signal relating to a current operating state of the port;
wherein the identification signal has a first characteristic and the signal relating to the current operating state of the port has a second characteristic, which is distinct from the first characteristic; wherein the first characteristic comprises blinking according to a first pattern and the second characteristic comprises blinking according to a second pattern that is visually distinguishable from the first pattern based upon one or more of (a) an interval between illumination and non-illumination and (b) a length of illumination or non-illumination;
wherein the method is performed by one or more computing devices.

20. The method of claim 19 wherein the first instruction further comprises pattern data that specifies a particular illumination pattern for the indicator from among a plurality of different available illumination patterns, and wherein at least one of the plurality of available illumination patterns is different than a second particular illumination pattern that is associated with normal operation of the particular port.

21. The method of claim 1 wherein the computer comprises any of a packet data router or switch.

22. The computer of claim 10 comprising any of a packet data router or switch.
